(19) United States
(12) Patent Application Publication
(10) Pub. No.: US 2008/0267361 A1
(43) Pub. Date: Oct. 30, 2008

(54) Public phone device with multiple functionalities including services for the hearing impaired

(76) Inventor: Walter R. Dileo, Miami, FL (US)

Correspondence Address: Walter R. Dileo, 13300 SW 69 Avenue, Miami, FL, 33156, US

(21) Appl. No.: 11/789,564

(22) Filed: Apr. 25, 2007

(51) Int. Cl. H04M 11/00

(52) U.S. Cl. 379/52; 379/93.22

(57) ABSTRACT

A public phone with enhanced communications services for the hearing impaired and hard of hearing.

### Technical field and background

The present application generally relates to providing multiple communication services, in particular, to a public phone with enhanced communications services for the hearing impaired and hard of hearing.

Currently available public phones offer audio and video communication services for the typical end user. These public phones can be accessible and conveniently placed in public places such as hotel lobbies, public areas of airports, schools, shopping centers, etc.

Conventional communication devices for the deaf, the hard of hearing, or the speech impaired, include Video Relay system (VRS), Telecommunication Relay Services (TRS) or Dual Party Relay Services (DPRS), which may comprise the use of a Text Telephone, such as Telecommunication Devices for the Deaf equipped with a keyboard (TDD/TTY). Currently available public phones are not properly equipped to provide these services to the hearing impaired. One of the problems that the hearing impaired faces is that in order to establish a connection with the desired party, the hearing impaired is forced to use these services only from places where these services are available and/or that are equipped with said special devices.

Therefore, what is needed is a public phone capable of providing multiple functionalities that target not only the typical end user, but also, and most importantly, the hearing impaired. It is intended that “hearing impaired” refers to the deaf, the hard of hearing, or the speech impaired. This is important especially when the hearing impaired is living abroad, working or studying away from home, and when on business or leisure trips.

Brief summary

In view of the foregoing, the present application is directed to a device, which is a public phone, capable to providing multiple functionalities that target not only the typical end user but also, and most importantly, approaches specific clients such as the hearing impaired and hard of hearing.

### BRIEF DESCRIPTION OF THE DRAWINGS

FIG. 1 is schematic diagram of the electronic intelligent switch.

FIG. 2 is schematic flow diagram of the menu and application modules according to the description of the present application.

FIG. 3 is schematic flow diagram of the VRS module according to the description of the present application.

FIG. 4 is schematic flow diagram of the TRS module according to the description of the present application.

FIG. 5 is schematic flow diagram of the TTY module according to the descriptions of the present application.

FIG. 6 is schematic flow diagram of the videoconference network according to the descriptions of the present application.

FIG. 7 is schematic flow diagram of the video and audio e-mail module according to the descriptions of the present application.

FIG. 8 is schematic flow diagram of the advertisement server and advertisement computerized module according to the descriptions of the present application.

FIG. 9 is a diagram of the telephone device of the invention.

### DETAILED DESCRIPTION

The public phone device described in the present application is capable of providing multiple functionalities to the user comprising regular audio and video telecommunication services and services to the hearing impaired. By regular audio and video telecommunication services, it is intended that the public phone described in this application, as for any traditional public payphone, is capable of providing a series of audio calls, video calls, video e-mails and regular e-mails. The public phone device described herein can be modified in various obvious respects by the skilled in the art, all of which are included in the present invention.

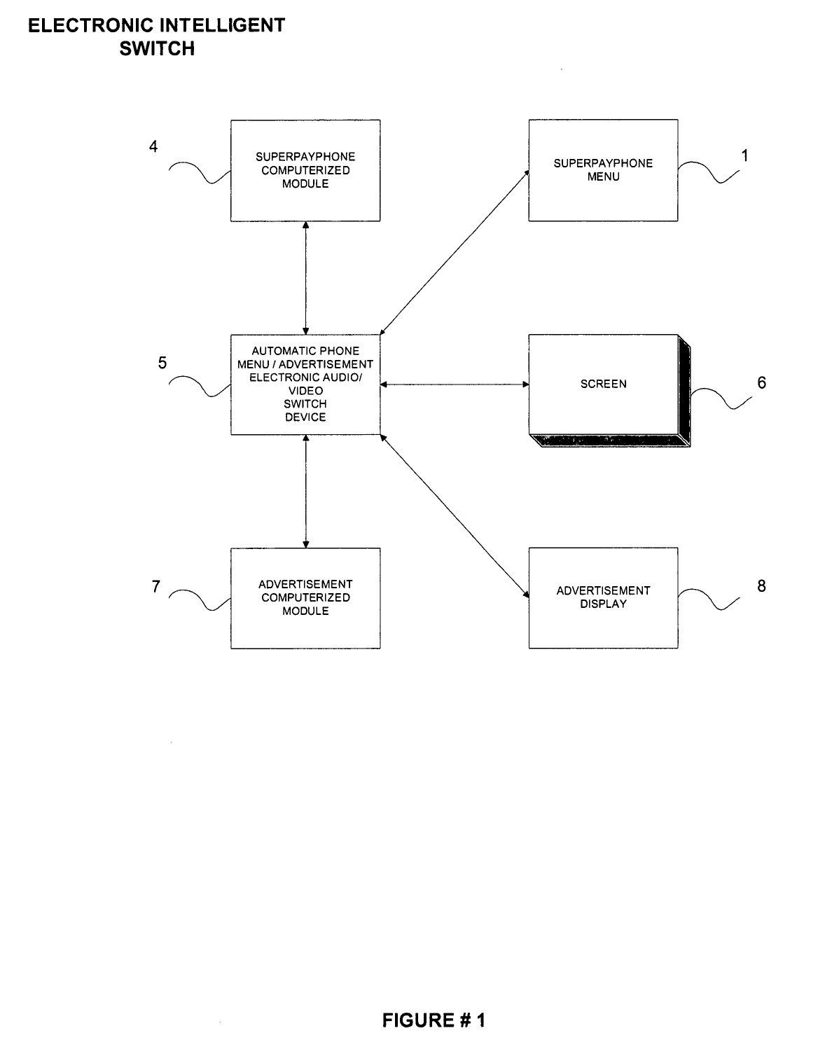

The public phone device described in the present application comprises an electronic intelligent switch (FIG. 1), wherein the computerized audio-video switching system 5, is capable of interacting with the main menu to access the service 1, the computer system 4, the liquid crystal screen 6, the advertisement computerized module 7 and the advertisement display 8.

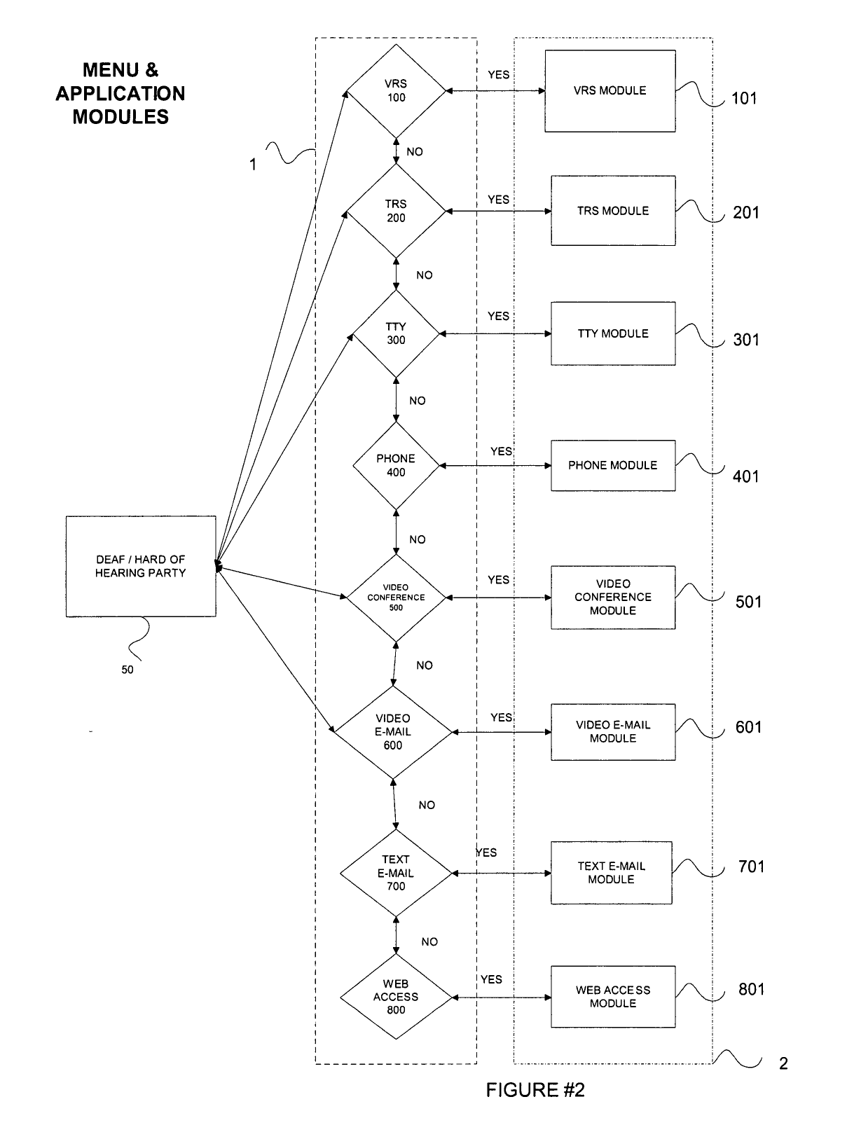

FIG. 2 summarizes the various embodiments 101-801 of the public phone device described in the present application. The VRS menu 100 allows the hearing impaired to use the VRS module 101 of the phone device described in the present application as a relay service to a VRS customer service center, where an interpreter will answer the video call and have the ability to generate a third party call to a regular phone line or service. Via the TRS menu 200 the hearing impaired can place a special text call through TRS module 201 to a TRS center where an operator can receive the call with a special text phone and generate a third party call with regular phones. The public phone described in the present application also allows the hearing impaired to place a call to any TTY device or TRS center via the TTY menu 300 and special TTY/TTD module 301. The device described in the present application is capable of providing regular phone calls through local, long distance and international communication service. Menu 400 and module 401 allows generating calls to any standard phone, cell phone, internet phone, soft phone, multimedia phone and/or any computer. The user will be able to dial out to any local, out of State or International phone number including toll-frees, 411 and emergency calls. The videoconference menu 500 and the videoconference module 501 of the phone device described in the present application allow the user to communicate to any video phone, video cell phone, set top video box, rack mountable codec and/or multimedia computer. The public phone described in the present application is also equipped with a video e-mail menu 600 and module 601, which allow the user to capture audio and live video, converting it to digital data and then sending it via regular e-mail. The phone device described in the present application is also capable of providing access to any web based e-mail server through a text e-mail menu 700 and module 701. The public phone described in the present application is also capable of providing access to World Wide Web in general through a WEB navigation menu 800 and a WEB access module 801.

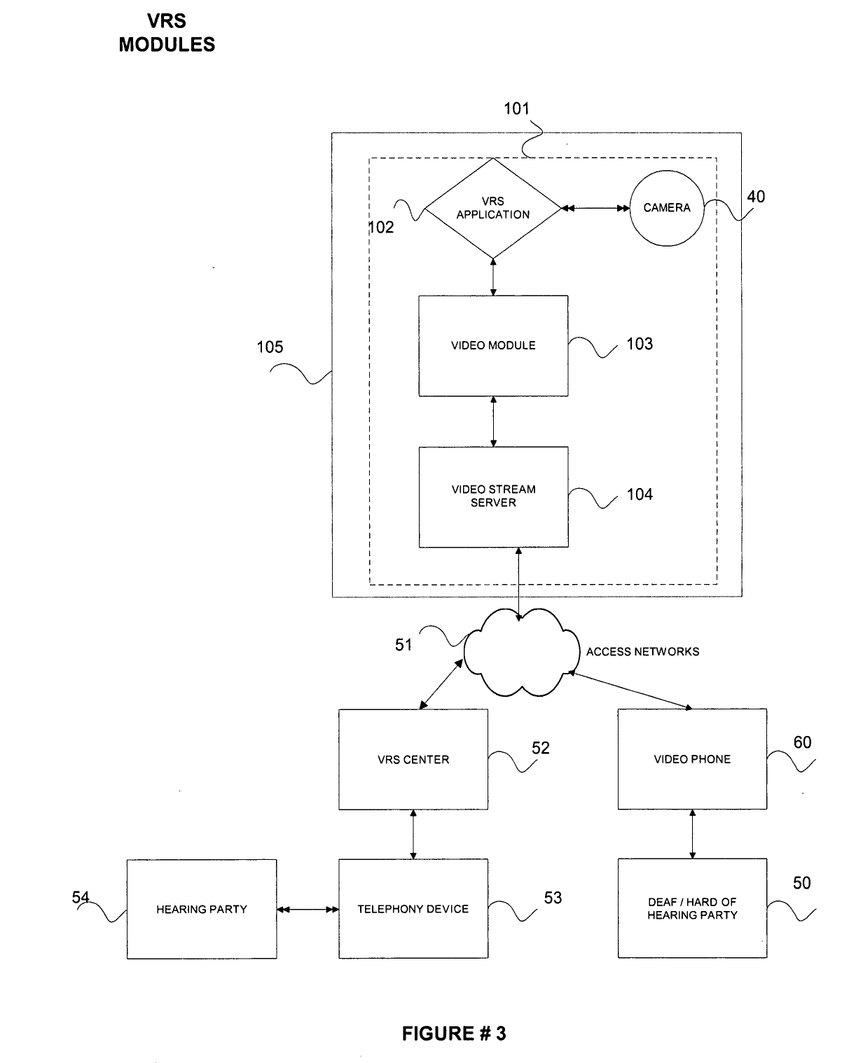

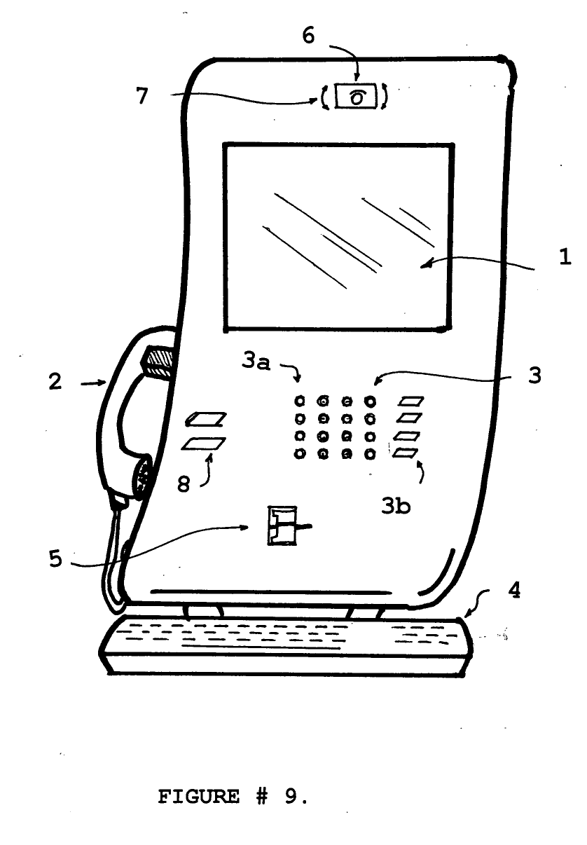

Referring to FIG. 3, one of the embodiments of the public phone described in the present application is to allow the hearing impaired 50 to communicate with a regular hearing party 54 via a VRS center. With the continuous growth of the VRS system, the public phone of the present invention is equipped with a speed dial button on the payphone keypad, keyboard and mouse-controlled software interface (See FIG. 9) that allows the hearing impaired to connect to a VRS operator with a one touch operation. The hearing impaired approaches the phone device described in the present application, presses the VRS button located in the keypad (6 of FIG. 9), or, suing the mouse, clicks on the screen software interface on the VRS icon. The user gets immediately connected to a VRS center, where the operator will start chatting using ASL (American Sign Language). The user does not need to lift the handset to perform this task. The link is provided by a videophone 60 or the phone device described in the present application, through access network 51. It should be recognized that 51 consists of two network accesses, namely (a) regular PSTN lines, and (b) IP Network (LAN-Internet). The service provider 52 with level 5 ASL operators (interpreters) manage video calls originated by the hearing impaired 50, and translate the content of the calls to regular hearing party 54, via telephone device 53. Telephone device 53 comprises, but is not limited to regular analog or digital audio phones, like cell phones, digital phones or IP phones. The VRS module 101 incorporated in the public phone described in the present application 105, comprises a VRS application 102 that captures local video, converts it to data and sends it to a sign language interpreter, who starts a third party call with regular phone lines, making possible a conversation between a hearing impaired person and a regular hearing party. The VRS module 101 also comprises a Video module 103, which comprises hardware and software that encode the video, compress it in real time and send it via the IP network (H.323, H.264/SIP protocols). The VRS module 101 also comprises a Video Streaming Server 104 software portion that takes the compressed video and pushes it directly to the receiving party; it also receives the video feedback and projects it into the local screen. The VRS module 101 also comprises a Video Capture Camera 40 directly connected to VRS application 102.

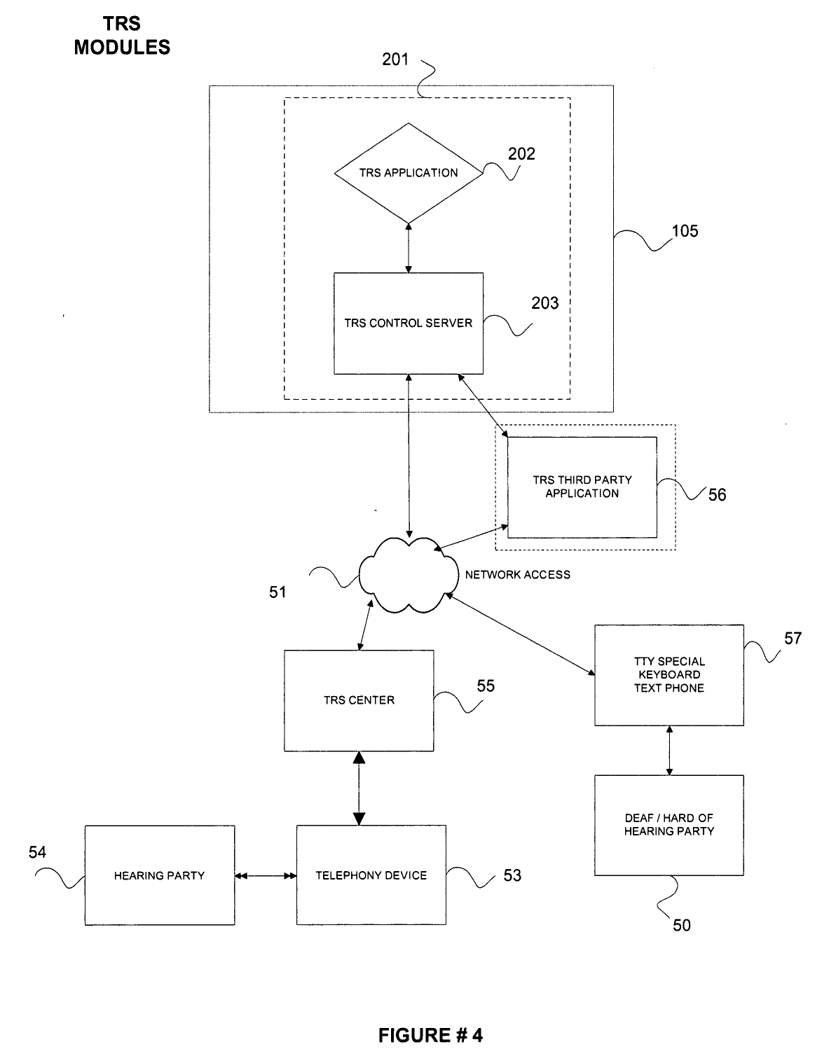

Referring to FIG. 4, another of the embodiments of the public phone described in the present applications is to provide the hearing impaired user 50 with a TRS service, allowing the user 50 to connect to a web based service where an operator or another end user 54 is able to chat with the user in multiple languages. The hearing impaired 50 through a TTY special keyboard text phone 57 is able to access network 51, which can be regular PSTN lines or IP network (LAN-internet), to and use to TRS application 202, through the TRS control server 203, which is a portion of software that handles the communication back and forth between the text telephone and the device of the present application; it also allows connections to thirds party TRS providers that handle calls between text phones and third hearing parties. The TRS center 55 is a call center with trained operators that receives text calls from hearing impaired users 50, initiates third party calls to a regular user 54 and serves as interpreter between the two parties.

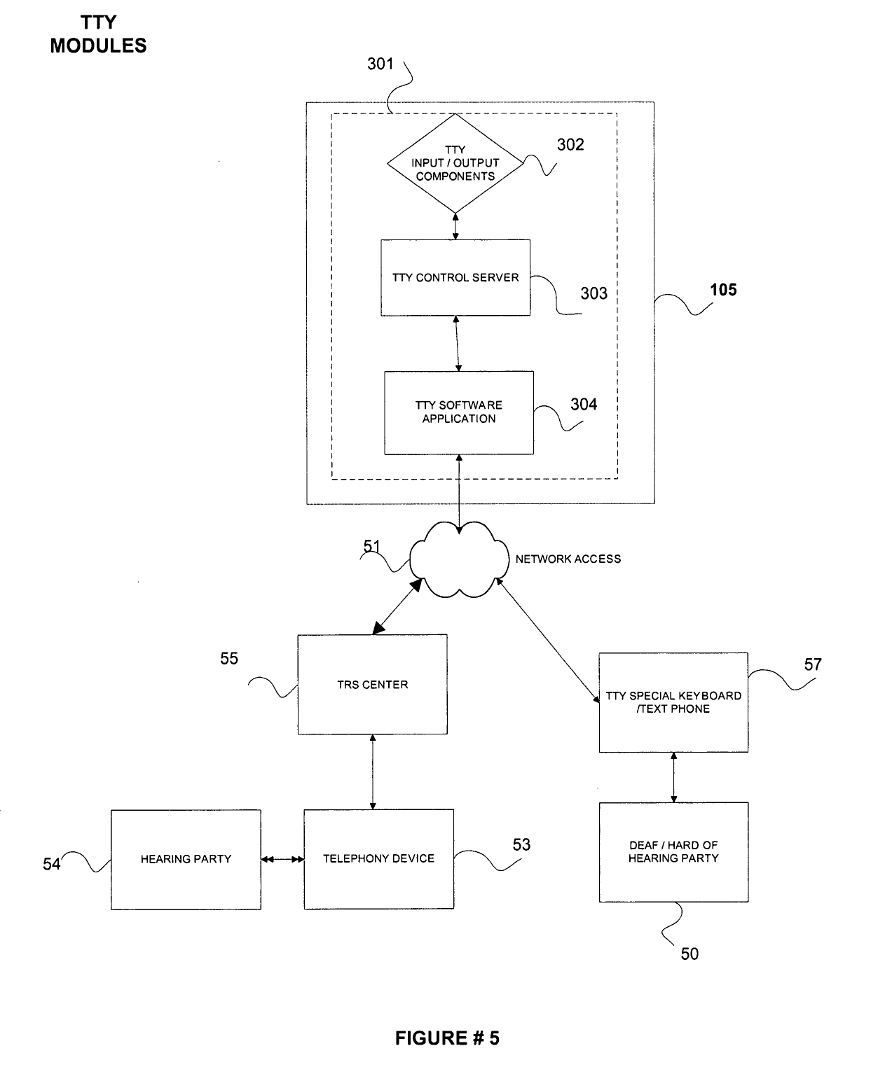

Referring to FIG. 5, another of the embodiments of the public phone described in the present applications is to provide the hearing impaired user 50 with TTY services. The phone device of the present application is equipped with a TTY module 301, comprising a TTY control server 303 that allows the VRS application to run and open a split window to have 2 parties text calls, modulating and demodulating all the text codes, and with a TTY input/output component 302; the input device is an integrated keyboard and the output device is a monitor, wherein the keyboard is interconnected via software to the monitor screen which generates and displays all text messages and data. Through the network access 51 and the TTY module 301, the hearing impaired 50 is able to communicate with a TRS center 55, wherein operators answer text calls and have the ability to connect those calls with another hearing party 54. TTY/TDD devices have been considered as the primary service and the most hearing impaired friendly devices by the FCC. After the hearing-impaired dials the terminating number, the receiving party sees the hearing-impaired user on the screen, the receiving party picks up the handset of the receiving telephone device and a face-to-face communication begins, as for regular users.

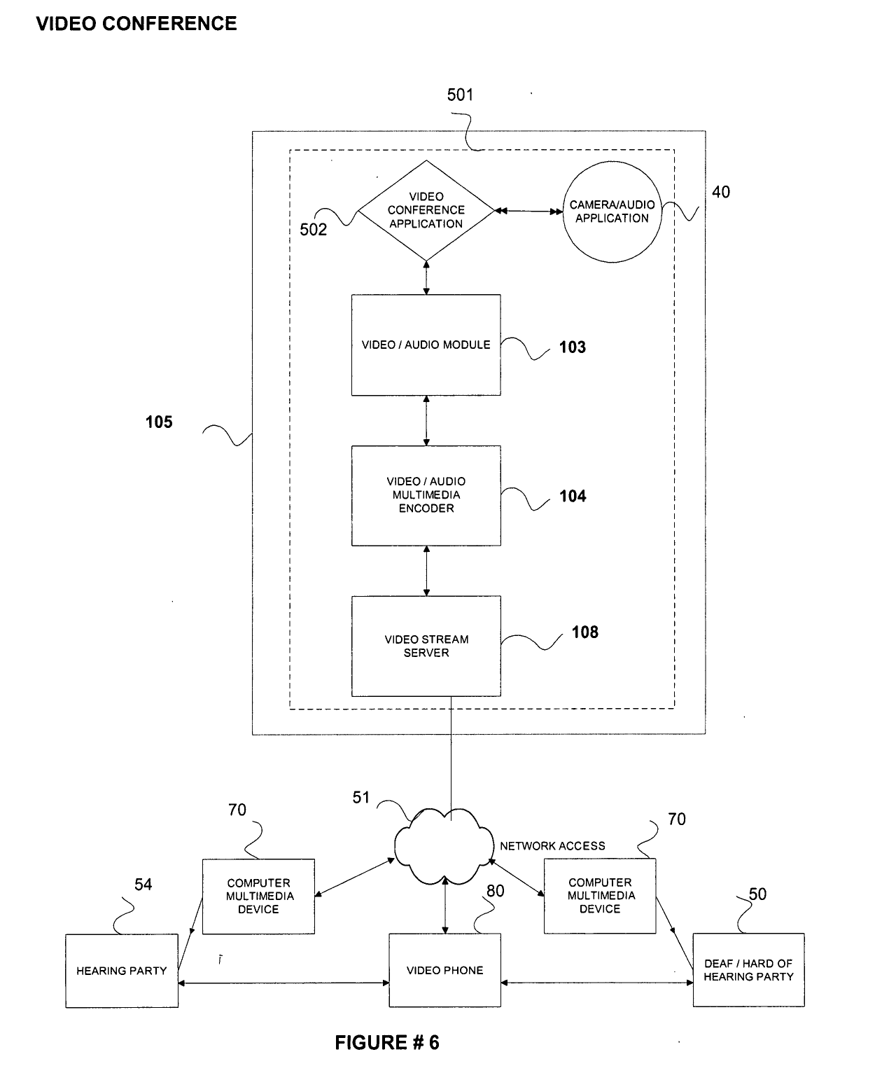

Referring to FIG. 6, another embodiment of the telephone device of the present invention is to deliver professional videoconferencing services. The telephone device of the present invention let the hearing impaired 50 and a regular user 54 share multiple connections of live video in real time mode with a minimum connection of two parties. The parties access the network 51 through a computer multimedia device 70, which is a computer capable to play and read multimedia archives or electronic mails, and through videophone 80 that allows the user to have a live videoconference or videophone call. Through a video stream server 108, and a video/audio multimedia encoder 104, which is a software designed to encode in secure mode the audio and video captured by module 103, and then convert it to data, the users can share multiple connections of live video in real time mode 502. The telephone device of the present invention is also equipped with a high-resolution video camera 40. The video capture camera can be easily adjusted with a touch of a finger to the proper height of the user.

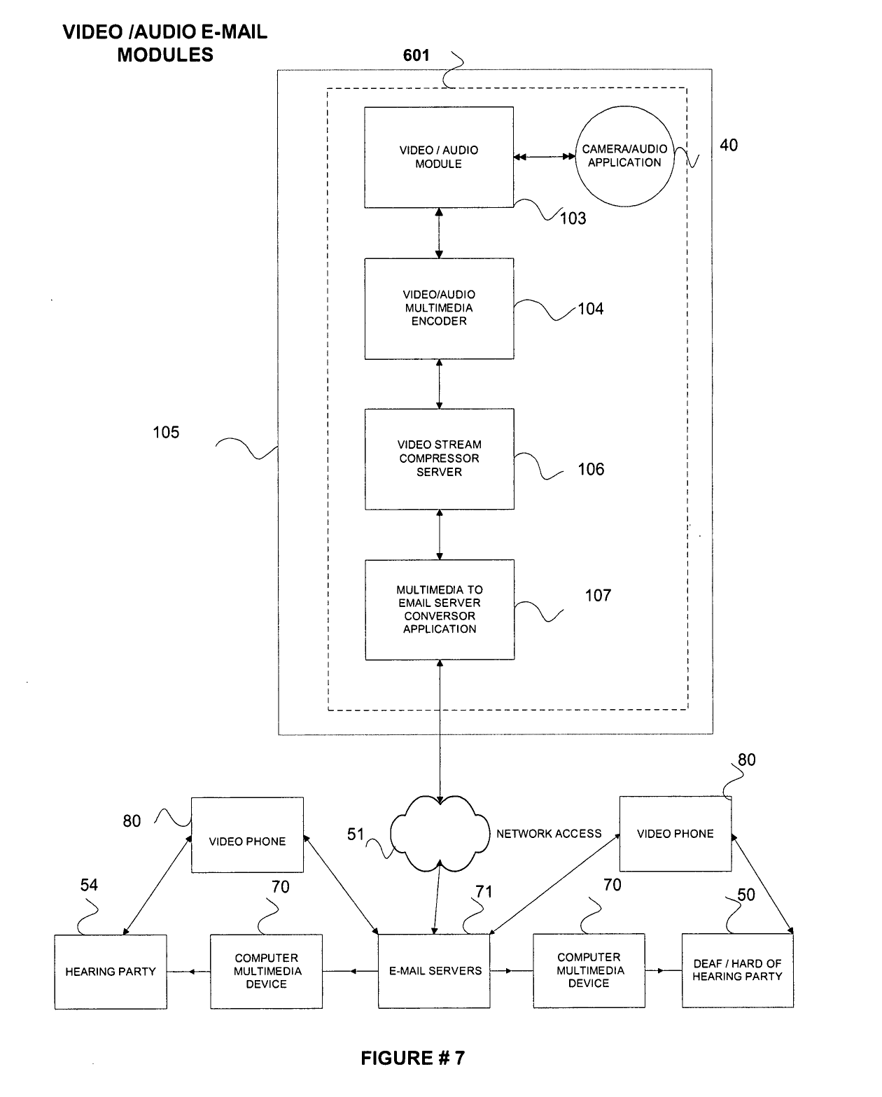

Another embodiment of the present application refers to the capacity to leave and deliver a video email in any regular e-mail address through a simple to use procedure. Additionally, the device of the present invention enables the user to send and receive e-mails from the most typical web-based email providers such us yahoo, gmail, hotmail, MSN and EarthLink, and to access and browse the WEB. Referring to FIG. 7 and similar to what was described for FIG. 6, the parties can access the network 51 via a videophone 80, or via a computer multimedia device 70 through an e-mail server 71. The phone of the present invention is capable of converting the audio and video signals to data via an encoder module 104, and further compressing the data in small format through a compressor server 106. The multimedia server converter 107 takes the small archive and converts it to multimedia format; in this way the archive cam be sent via regular e-mail servers and also can be read in any computer capable to see basic videos or any video phone.

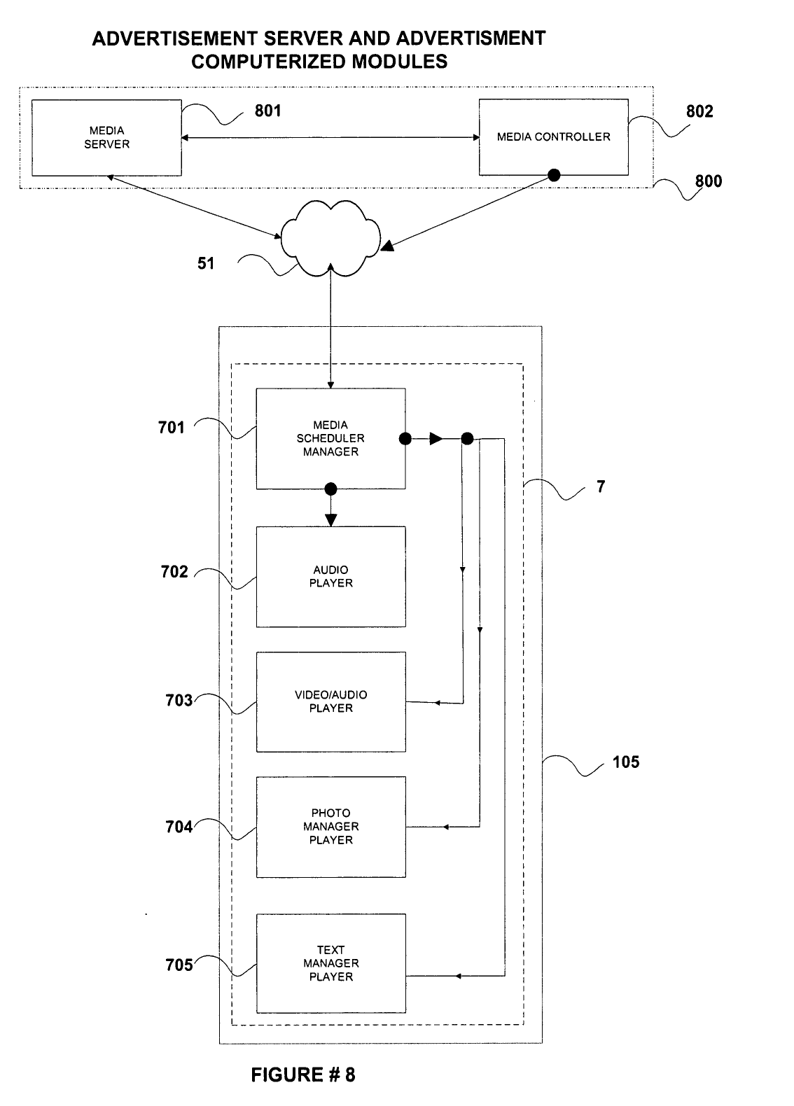

In a further embodiment, the device described in the present application is capable to displaying advertisements, broadcasting TV, video streaming capabilities, still pictures and scrolling text messages. The advertisement player will kick in after 30 seconds the device is in stand by mode and will be immediately interrupted anytime the user lifts the handset or presses any button on the keypad or the keyboard. The device of the present invention allows the user to download almost any video format, still pictures and word sentences into multiple units and show them on the screen in three different locations. Still pictures can be shown on one quarter of the right vertical side of the screen; word sentences can be shown on one quarter of the lower horizontal part of the screen (that will move right to left, left to right or will simply blink); full motion video can be shown in the main part of the screen. An integrated internal speaker provides full audio to the motion video(s). Simple management software will allow the user to download several hours of videos to up to 400 devices simultaneously. Through this software the user will also be able to broadcast any TV channel. Additionally, said software will permit the showing of still pictures and any moving text message of, for instance, social interest or warnings. The device of the present invention is also capable to display advertisements. The advertisement player will kick in after 30 seconds the device is in stand by mode and will be immediately interrupted anytime the user lifts the handset or presses any button on the keypad or the keyboard. Referring to FIG. 8, this is accomplished through advertisement servers 800 and advertisement computerized modules 700. Media Server 801 is a mix of hardware and software that can hold up to 30 days media information to be played by the advertisement player unit; it can storage Audio files, Video files, Images and Text files. Media Controller 802 organizes all the media, creates an archive library and controls the time and date when all the media must be uploaded and/or updated in every single device of the present invention. It can control a single device or multiple devices simultaneously. Advertisement computerized modules comprise a Media Scheduler Manager 701 which controls the time and date when the device has to play every portion of the media; it also has the ability to remove content and renew it. This unit also has the ability to change the distribution on the screen up to 9 options and positions as: (i) videos only, (ii) photos only, (iii) text only, (iv) video and text; (v) photos and text, (vi) videos and photos, (vii) photos, text and videos, (viii) text, photos and videos, and (ix) video, photos and text. Audio player 702 plays all the audio files that the unit may have in storage, also plays the audio for every video file; Video/Audio Player 703 plays any video that is sent to every device of this application, simultaneously with the other content (text files, photos and audio files); Photo Manager Player 704 reads and plays multi formats of graphic images, like (but not limited to): GIF, JPG, JPEG, JIFF, JPE, PNG; It reads the images from the storage and projects the images into the liquid crystal display of the device described in the present application, simultaneously with the other content (text files, audio files and video files); text Manager Player 705 reads text messages in ASCII, plain, digital or analog format and converts them to a special JPEG format to be played in a scroll bar as animation, simultaneously with the other contents (photos, audio files and video files).

The telephone device of the present invention comprises a LCD screen protected by a high-level impact glass (1, FIG. 9). It is intended that the device of the present invention may also comprise touch screen capabilities and Lexan glass. The telephone device of the present invention can deliver clear picture quality traveling to speed up to 4 megabite/second or MBPS. In general, the user dials the terminating telephone number at the appointed day and time. Once the receiving party sees the user on the screen, the receiving party picks up the handset of the receiving telephone device and a face-to-face communication begins. All the latest videoconferencing protocols (H.323, H.265/SIP) are supported.

The public telephone device of the present invention is also equipped with a keypad (3 of FIG. 9), which provides alphanumeric keys with a brail dot located on number 5 and 8 functional keys. The keypad includes but is not limited to a Zinc Aluminum alloy keypad. The four keys located on the left side of the alphanumeric keys (3a of FIG. 9) are assigned to the primary four functionalities of the device, i.e.: VRS calls, TTY calls, Audio calls and Video calls. The four keys located at the right of the alphanumeric keys (3b of FIG. 9) are assigned to (i) initiate a call (CALL button), (ii) provide picture-in-picture capability (PIP button), (iii) delete a digit that was inserted by mistake (DELETE button) and (iv) mute the audio during a call (MUTE button).

The telephone device of the present invention is also equipped with a high-resolution video camera (6 of FIG. 9). The video capture camera can be easily adjusted with a touch of a finger to the proper height of the user. Two directional arrows have been placed on its sides to show the user this option (7 of FIG. 9). The public telephone device of the present invention is also equipped with an industrial-grade stainless steel keyboard located on a robust support (4 of FIG. 9). The keyboard comprises an integrated mouse ball that allows the user to perform several functions including but not limited to: navigate through the software interface and choose the type of service the user wants, check the rates for a specific service, look at the instructions on how to operate the unit. The keyboard also comprises some keys that allow the user to select the services offered by the device (VRS, TTY, TRS, Audio Call, Video Call, Video E-mails, Text E-mails) and access the same functionality keys located at the right hand side of the keypad, as well the volume control keys. The public telephone device of the present invention also has handset and its lanyard. The handset (2 of FIG. 9) is a professional device used for traditional public payphones and the stainless steel lanyard has a pulling power of over 500 pounds (1000 kilograms) and is internally secured by a bracket that avoid anybody from pulling it out the device.

The public phone described herein also allows a choice of variety of credit card, debit card and calling card for the convenience of the user (5 of FIG. 9).

What is claimed is:

1. A device capable of providing multiple functionalities comprising:
Regular audio and video telecommunication services, and
Hearing impaired services.

2. The device of claim 1, wherein the device is a public telephone device.

3. The device of claim 2, wherein the public telephone comprises:
means for providing regular audio capabilities;
means for providing advertisement display;
means for delivering professional videoconferencing capabilities;
means for delivering of video and text emails;
means for establishing multiple party email communications;
means for accessing and browsing any web;
means for allowing the hearing impaired and/or hard of hearing to connect to a VRS operator;
means for allowing the hearing impaired and/or hard of hearing to connect to a TRS operator; and
means for allowing the hearing impaired and/or hard of hearing to establish communication through a TTY/TDD call.

4. The device of claim 3, further comprising means for accepting multiple types of payment via credit, debit and calling cards.

5. The device of claim 4, wherein the means for providing advertisement display comprises a series of advertisement computerized modules, wherein said modules are a media scheduler manager, an audio player, a video/audio player, a photo manager player, and a text a manager player.

6. The device of claim 4, wherein the means for providing professional videoconferencing capabilities comprise a video stream server, a video/audio multimedia encoder, a video/audio module, an video conference module application and a camera/audio application.

7. The device of claim 4, wherein the means for delivering of video and text emails comprises a multimedia to e-mail server conversor, a video stream compressor server, a video/audio multimedia encoder, a video/audio module, and a video capture camera.

8. The device of claim 4, wherein the means for allowing the hearing impaired to connect to a VRS operator comprises a video stream server, a video module, a VRS application, and a video capture camera.

9. The device of claim 4, wherein the means for allowing the hearing impaired to connect to a TRS operator comprises a TRS control server, and TRS application, wherein a TRS third party application connects the TRS application with a TRS center.

10. The device of claim 4, wherein the means for allowing the hearing impaired to establish communication through a TTY/TDD call comprises a TTY software, a TTY control server, and TTY input/output component.

11. The device of claim 2, wherein the public telephone comprises:
a LCD screen;
a keypad, wherein the keypad provides alpha numeric keys with a brail dot and multiple functional keys;
a keyboard, wherein the keyboard comprises a mouse ball and multiple functionality keys;
a high resolution camera;
a handset; and
a lanyard.

12. A system comprising:
a videophone configured to:
provide regular telephone calls;
provide professional videoconferencing capabilities;
provide email capabilities and access to the WEB;
provide VRS, TRS and TTY/TDD services for the hearing impaired; and
provide multimedia advertisement and broadcasting to any TV channel; and
a software configured to:
allow the user the possibility to access the services;
look at rates;
check operating instructions, and;
provide real time instructions and information during user experience.
